(19) United States
(12) Patent Application Publication
(10) Pub. No.: US 2025/0389611 A1
(43) Pub. Date: Dec. 25, 2025

(54) SYNCHRONOUS MEASUREMENT SYSTEM AND METHOD FOR PRESSURE AND DEFORMATION OF ROTATING BLADE

(71) Applicant: NORTHWESTERN POLYTECHNICAL UNIVERSITY, XI'AN CITY (CN)

(72) Inventors: Bo Ouyang, Xi'an City (CN); Limin Gao, Xi'an City (CN); Zhibo Zhang, Xi'an City (CN); Jun Zhang, Xi'an City (CN); Ruiyu Li, Xi'an City (CN); Ning Ge, Xi'an City (CN)

(21) Appl. No.: 19/246,258

(22) Filed: Jun. 23, 2025

(30) Foreign Application Priority Data
Jun. 24, 2024 (CN) 202410821631.3

(51) Int. Cl. G01M 5/00

(52) U.S. Cl. CPC G01M 5/005; G01M 5/0091

(57) ABSTRACT

This invention relates to a system and method for synchronous measurement of pressure and deformation on the surface of a rotating blade. The system consists of a binocular camera, a light source, a digital delay generator, a photoelectric rotational speed sensor, a counter and PSP paint. The method involves the following steps. Firstly, prepare a PSP coating with marker points on the surface of the measured blade. Then, perform binocular calibration and obtain the phase-locked position. Control the opening of the shutter of the binocular camera and then trigger the light source to emit stroboscopic illumination at the phase-locked position. When the image has accumulated sufficient intensity, the counter breaks the circuit and the shutter is closed. Subsequently, substitute the calibration parameters of the binocular camera and the PSP, register and conduct three-dimensional reconstruction on the obtained images to obtain the three-dimensional pressure and deformation values on the blade surface.

### PRIORITY

This application claims priority to Chinese Patent Application Serial No. 202410821631.3, filed Jun. 24, 2024, entitled “A Synchronous Measurement System And Method For Pressure And Deformation Of Rotating Blade,” the entire disclosure of which is incorporated herein by reference.

### TECHNICAL FIELD

This invention relates to the field of fluid-solid coupling test measurement of turbomachinery. A synchronous measurement system and method for pressure and deformation of rotating blade are involved.

### BACKGROUND

Rotor blades are components for direct functional conversion between aero-engine and air. The aerodynamic performance of rotor blades directly affects the efficiency and stability of the aero-engine. Compared with rotor blades in a stationary state, rotating blades are subjected to not only the aerodynamic load but also the substantial centrifugal force from high-speed rotation. Under the influence of these two factors, the shape of the rotating blade will undergo deformation. For example, the blade will elongate in the radial direction and thinner in the circumferential direction. This, in turn, will alter the position and magnitude of the force exerted by the blade on the airflow. Measuring the aerodynamic pressure and deformation of the blade surface in motion is of great significance for preliminary blade design.

Rotating blades exhibit high-speed motion. When applied to rotating model surfaces, the traditional pressure measurement technology based on pressure sensors encounters challenges such as installation complexity, data transmission obstacles, and test platform modification. Similarly, strain gauge-based blade strain measurement faces analogous limitations and can only yield localized deformation data.

Pressure sensitive paint (PSP) is a model surface pressure measurement method based on optical signal. With the advantages of non-contact measurement, no modification of the measured model and global measurement, PSP technology has been widely used in the surface pressure measurement of rotating models. The digital image correlation (DIC) method based on binocular stereo vision obtains the model deformation parameters by tracking the displacement of specific pixels on the image after deformation. It also has the advantages of non-contact measurement, no modification of the measured model and global measurement, and has good application potential in rotor blade deformation measurement.

Chinese invention patent CN115615589A proposes a global pressure measurement system and method for rotating models. A high image signal-to-noise ratio is achieved by integrating multiple short-duration PSP luminescence events into a single long-exposure image. This approach exhibits robust adaptability to rotational speed variations, yet remains limited to measuring surface pressure parameters on blades.

Chinese patent CN114152210A discloses a synchronous measurement method for acquiring three-dimensional continuous distributions of surface pressure and deformation on high-speed aircraft. This technology achieves integrated surface pressure and deformation measurements on moving models through concurrent yet independent implementation of digital image correlation (DIC) and PSP techniques. However, this technology does not realize the integration of DIC and PSP technologies, and the measured pressure cannot be directly mapped to the deformation model. The numerous speckles required by the DIC method interfere with PSP luminescence, thereby reducing the spatial resolution of PSP measurements.

The paper published in the journal Measurement, “Simultaneous pressure and deformation field measurement on helicopter rotor blades using a grid-pattern pressure-sensitive paint system”, Chinese patent CN114354036B, and Chinese patent CN113155399B all proposed a simultaneous measurement technology of surface deformation and pressure of rotating models based on PSP technology and DIC method. The feasibility of integrating PSP technology with speckle markers was explored. At high rim speeds, lifetime-based PSP technology demonstrates limited improvements in image signal-to-noise ratio and motion blur suppression. Consequently, this approach is ill-suited for pressure measurements on high-speed rotating blades.

PSP technology and DIC method have been used to measure the surface pressure and deformation of rotating blades, respectively. However, the fusion of the two methods has the problem that the image features are difficult to identify, and faces the serious limitation of image motion blur on the high-speed rotation model. It is of great value to solve the limitation of image motion blur and image signal-to-noise ratio under high-speed rotating model for high precision synchronous measurement of surface pressure and deformation of rotating blade.

### BRIEF DESCRIPTION OF THE DRAWINGS

FIG. 1 illustrates the schematic diagram of the synchronous measurement system for the surface pressure and deformation of rotating blades proposed by the invention.

FIG. 2 illustrates the schematic diagram of the image processing flow for the surface pressure and deformation of rotating blades proposed by the invention.

FIG. 3 illustrates a stationary PSP blade with marker points in this embodiment, in which: 1. Binocular camera; 2. Zoom lens; 3. Optical filter; 4. Light source; 5. Digital delay generator; 6. Photoelectric speed sensor; 7. Counter; 8. reflective sticker; 9. PSP; 10. Marking points; 11. The measured blade; 12. Computer.

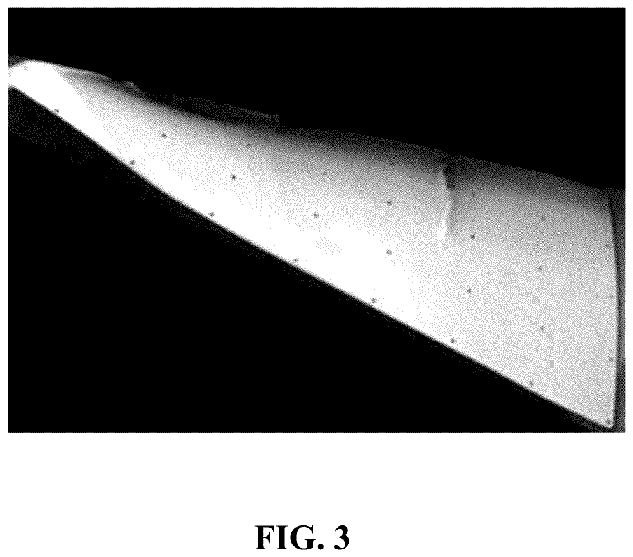

### INVENTION DESCRIPTION

The present invention aims to address the application challenges of existing pressure measurement and deformation measurement technologies for rotating blades, providing a synchronous measurement system and method capable of acquiring high signal-to-noise ratio and high-definition rotating blades surface pressure and deformation data.

On the one hand, the present invention provides a synchronous measurement system for pressure and deformation of rotating blades, as detailed below.

(1) A synchronous measurement system for pressure and deformation of rotating blades. Specific components include: binocular camera, digital delay generator, photoelectric speed sensor, computer, light source, reflective sticker, pressure sensitive paint, counter.

(2) The surface of the measured blade is uniformly sprayed with PSP. A set of marking points is arranged on the PSP coating.

(3) The photoelectric speed sensor is aligned with the reflective label pasted on the shaft of the measured blade. When the measured blade rotates to a fixed position each time, the photoelectric speed sensor emits a phase-locked signal and transmits it to the digital delay generator. This fixed position of the blade is defined as the phase-locked position.

(4) The binocular camera, equipped with lenses and optical filters, is used for image acquisition. Its focal length and field of view sufficiently capture the global PSP luminescence intensity on the model surface. The binocular camera is connected to the computer via data cables for real-time image transmission. The light source's illumination area fully covers the PSP coating to achieve global excitation.

(5) The digital delay generator establishes signal communication with both the binocular camera and the light source to control the synchronous opening/closing of the binocular camera shutter and the stroboscopic illumination of the light source. The counter, positioned between the digital delay generator and the light source, is used to record the number of stroboscopic flashes of the light source.

Preferably, the optical filter is a band-pass filter with a wavelength range matching the peak emission spectrum of the PSP.

Preferably, the light source features active cooling and an externally triggered stroboscopic function, with stroboscopic illumination stability exceeding 99.5%.

Preferably, the digital delay generator is equipped with two independent signal output channels and an external trigger signal input channel.

On the other hand, this invention also provides a synchronous measurement method for surface pressure and deformation of rotating blades. The method specifically comprises the following steps.

Step 1: Establish the above-mentioned synchronous measurement system for pressure and deformation of rotating blades.

Step 2: Adjust the measured blade to rotate at the target speed. Upon stabilization, synchronously trigger the binocular camera shutter to open. Each time the measured blade reaches the phase-locked position, Whenever the measured blade reaches the phase-locked position, control the light source for stroboscopic illumination to regulate the motion blur length. The counter synchronously records the number of stroboscopic flashes. When the image has accumulated sufficient signal-to-noise ratio at the phase-locked position, synchronously close the binocular camera shutter. The camera exposure time T and counter count N are recorded, and a pair of binocular images at the phase-locked position are acquired (hereinafter referred to as “binocular wind-on images”).

Step 3: Repeat Step 2 after setting the target speed in Step 2 to the barring speed of the rotating blade, thereby acquiring a pair of binocular wind-off images at the phase-locked position.

Step 4: Calibrate the binocular camera to obtain its internal and external parameters.

Step 5: Identify and match the marker points in both the binocular wind-off images and binocular wind-on images. Then, calculate the deformation information between the two images by combining the internal and external parameters of the binocular camera. After registering the binocular wind-on images to the binocular wind-off images using the deformation information, compare the two images to obtain the PSP intensity ratio of the blade surface.

Step 6: By substituting the calibration relationship of PSP, the intensity ratio of PSP on the blade surface can be converted into pressure. Synchronous measurement of blade deformation and pressure is realized.

According to the above scheme, in step 2, the image signal-to-noise ratio should not be less than 30 dB after the exposure time T of the binocular camera is ensured. The formula for calculating the signal-to-noise ratio is:

SNR=20×1g(I₂/I₁),

Where I₂ is the grayscale value of the measured blade surface in the image, and I₁ is the grayscale value of the area without the measured blade in the image.

According to the above scheme, in Step 2 and Step 3, the delay time is used to ensure that the binocular camera can fully capture the photo-luminescence process of the PSP during its N-time excitation by the light source.

According to the above scheme, in step 2 and step 3, the calculation formula for the single stroboscopic illumination time t of the light source is as follows.

$$t = L / v .$$

Here, L is the acceptable image motion blur length, and v is the tip speed of the measured blade at the target speed, which can be calculated from the rotation radius and angular velocity of the measured blade tip.

According to the above scheme, in step 6, the calibration relationship of PSP is as follows.

$${I}_{ref} / I = A + B \times P / {P}_{ref} ,$$

Here, I_{ref} and I represent the luminous intensity of PSP on the surface of the blade in the wind-off state and wind-on state, respectively. A and B are the calibration coefficients of PSP.

Compared with the prior art, the beneficial effects of the present invention are as follows.

(1) The system and method proposed by the invention can realize the synchronous measurement of the surface pressure and deformation of the rotating blades. This method integrates PSP technology with benefits of the DIC method. Through feature recognition and matching of PSP-coated surfaces bearing uniformly distributed markers, it achieves synchronous acquisition of surface pressure and deformation parameters on rotating models.

(2) The measurement technology encompassed by the invention demonstrates a remarkable capacity to effectively diminish the motion blur length of the image. It further presents the benefits of high definition and a high signal-to-noise ratio, ensuring clear and accurate results. Additionally, this technology exhibits excellent adaptability and applicability within high-speed working conditions, rendering it highly suitable for a diverse array of applications in such challenging environments.

(3) The measurement system offered by the invention entails relatively low requirements for binocular cameras and light sources, possessing the features of low cost and easy accessibility.

### Manner Of Implementation

To facilitate a deeper understanding of the invention, a detailed description thereof is given in conjunction with the drawings and a specific implementation example.

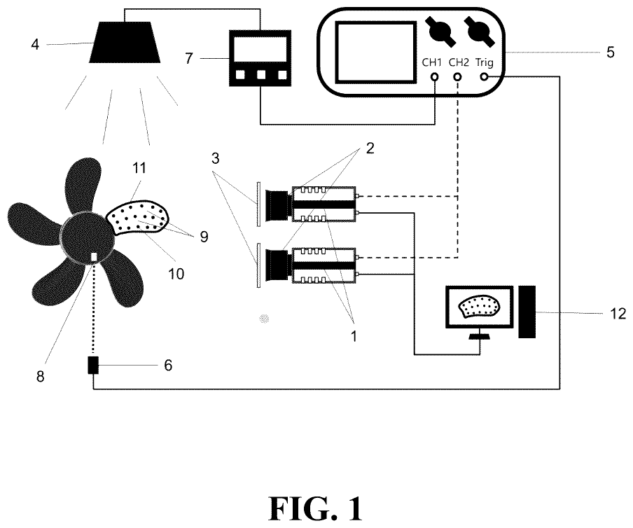

As shown in FIG. 1, the implementation example presents a synchronous measurement system for the surface pressure and deformation of rotating blades.

The binocular camera (numbered 1) is used for simultaneously acquiring PSP images.

The zoom lens (numbered 2) is used to adjust the field of view of the measured blade (numbered 11) in the PSP image.

The filter (numbered 3) is utilized to filter out the interference light within the non-PSP band.

The light source (numbered 4) is used for stroboscopic excitation of PSP.

The digital delay generator (numbered 5) is employed for the timing trigger control over the binocular camera and the light source.

The photoelectric speed sensor (numbered 6) and the reflective sticker (numbered 8) are utilized to detect the phase of the measured blade and generate a trigger signal that controls the digital delay generator 5 to start working.

The counter (numbered 7) is utilized to record the stroboscopic times of light source.

The PSP (numbered 9) is used to measure the surface pressure of the measured blade.

The measured blade (numbered 11) serves as the measurement object in the implementation example.

The computer (numbered 12) is utilized for controlling the binocular camera and performing post-processing on PSP images.

The construction steps of the synchronous measurement system for the surface pressure and deformation of rotating blades provided in this implementation example are as follows.

(1) Uniformly spray the PSP on the surface of the measured blade by air spraying.

As an optional implementation approach, the PSP coating is prepared on-site, and the PSP coating 9 is uniformly sprayed onto the surface of the measured blade 11 using an air spray gun.

(2) Arrange the marking points 10 on the surface of the measured blade 11 coated with PSP 9. The measured blade 11 with the marking points 10 arranged is shown in FIG. 4.

As an optional implementation approach, the marker points are required not to corrode or dissolve the nearby PSP. Moreover, the marker points can be evenly distributed on the global surface of the measured blade.

(3) Rotate the measured blade to the phase-locked position, and then attach the reflective sticker 8 to its rotating shaft. Align the photoelectric rotational speed sensor 6 with the reflective label, so that whenever the measured blade 11 rotates to the phase-locked position, the photoelectric rotational speed sensor can be triggered by the reflective label. Connect the photoelectric rotational speed sensor 6 to the Trig channel of the digital delay generator 5 via a data cable for the transmission of the phase-locking signal.

As an alternative implementation mode, the attachment position of the reflective sticker 8 can be either on the rotating shaft or on other non-target measured blades. It is necessary to make the reflective sticker 8 as far away from the target measured blade 11 as possible. The marker points 10 can be evenly distributed over the entire surface of the blade. The Trig channel of the digital delay generator 5 is an external trigger signal input channel, serving as the reference clock for the signal output channels CH1 and CH2 of the digital delay generator 5.

(4) Integrate the binocular camera 1, the zoom lens 2 and the optical filter 3 into one unit by means of threaded interfaces, and then align them with the measured blade 11. Connect the external trigger interface of the binocular camera 1 to the signal output channel CH2 of the digital delay generator 5. Align the light source with the measured blade. Connect the external trigger interface of the light source 4 to the signal output channel CH1 of the digital delay generator 5 via a counter 7 through data cables.

As an alternative implementation mode, when the binocular camera 1 is being installed, the aperture, focal length and magnification of the zoom lens should be adjusted so that the measured blade 11 fully appears in the image on the computer 12 and occupies more than 50% of the image's pixels. The light source 4 is capable of globally exciting the PSP on the surface of the measured blade 11. The physical dimensions of the zoom lens 2 and the optical filter 3 should match the interface of the binocular camera 1.

This embodiment provides a synchronous measurement method for the surface pressure and deformation of rotating blades, which specifically includes the following steps.

Step 1: Provide and construct the above-mentioned synchronous measurement system.

Step 2: Set the light source 4 and the binocular camera 1 to the external trigger mode on the rising edge, with the illumination mode being stroboscopic emission; set the trig external trigger signal input channel of the digital delay generator 5 to the off state.

In this embodiment, the rotational speed of the measured blade is 4440 rpm, which corresponding to a tip speed of 217 m/s. The length of motion blur L is specified to be less than 0.5 mm.

Step 3: Set the signal mode of the CH1 channel of the digital delay generator to “Burst”, with the output quantity being 1. Set the high-level width to t, and select the auto-continuous trigger as the trigger mode. Manually trigger the binocular camera for long exposure until the SNR of the image is greater than 30 dB. Record the count N of the counter and the exposure time T of the binocular camera. Change the trigger mode setting of the CH1 channel of the digital delay generator 5 to external, and set the initial delayed trigger time. Set the signal mode of the CH2 channel of the digital delay generator 5 to “Burst”, with the output quantity being 1 and the frequency being 1/T. Select the external as the trigger mode, and set the initial delayed trigger time to 0. The preset count value of the counter is N, and an open circuit will be formed when the count exceeds N.

In this embodiment, t=2.3 μs, N=9000, T=42 ms, and the delay time is 10 μs.

Step 4: The external trigger interface of the digital delay generator 5 was preset to the off state. Turn on the external trigger interface after adjusting the measured blade 11 to reach the target rotational speed. The CH1 and CH2 channels of the digital delay generator 5 are triggered by the phase-locked signal and send trigger signals to the binocular camera 1 and the light source 4 respectively according to the preset values. After being triggered, the binocular camera 1 performs image acquisition with an exposure time of T for one time. During this period, the light source 4 continuously emits stroboscopic illumination. The counter counts the number of stroboscopic illuminations synchronously. When the count reaches N, the signal transmission between the digital delay generator 5 and the light source 4 is interrupted. Then the shutter of the binocular camera 1 is closed subsequently. At this time, the acquisition of the wind-on image has been completed.

Step 5: Turn off the measured blade 11, and after it comes to a complete stop, rotate the measured blade 11 to the phase-locked position. Change the trigger mode of the CH1 channel of the digital delay generator 5 to auto-continuous trigger. Manually trigger the trig port of the digital delay generator 5 once. The CH1 and CH2 channels of the digital delay generator 5 then send trigger signals to the binocular camera 1 and the light source 4 respectively, according to the preset values. The binocular camera 1 first opens its shutter to acquire a pair of images with an exposure time of T. After a delay time, the light source 4 starts to emit stroboscopic illumination continuously, following the trigger signal of the CH1 channel of the digital delay generator 5. The counter 7 counts synchronously. When the count value reaches the preset value N, the signal transmission between the digital delay generator 5 and the light source 4 is interrupted. After a delay time, the binocular camera 1 simultaneously closes its shutter, thereby obtaining a set of binocular reference images, and stores them in the computer 12.

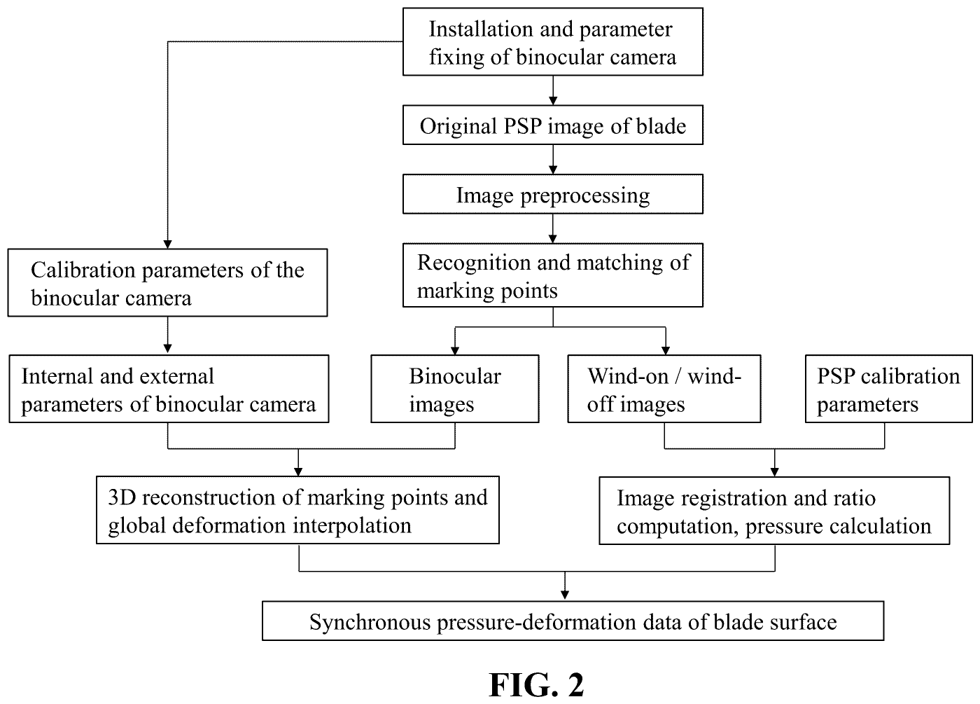

Step 6: As shown in FIG. 2, keep the relative positions and parameters of the system unchanged, and use the calibration plate to perform binocular calibration on the image acquisition system composed of the binocular camera 1, the zoom lens 2 and the optical filter 3, so as to obtain the internal and external parameters of the image acquisition system.

Step 7: Identify and match the marker points on the surface of the binocular images. On the one hand, bring in the internal and external parameters of the binocular image acquisition system to solve the deformation relationship between the binocular images. On the other hand, register the binocular wind-off images and the binocular wind-on images according to the matched marker points. After performing comparison and processing operations, bring in the calibration parameters of the PSP paint to calculate and obtain the pressure distribution on the blade surface. Map the pressure onto the blade geometry through the deformation information, and then the synchronous pressure and deformation on the surface of the rotating blade can be obtained.

The typical embodiment of the present invention has been described in detail above.

1-3. (Canceled)

4. A synchronous measurement system for measuring pressure and deformation of rotating blades, wherein the rotating blades include a measured blade having a surface coated with a pressure-sensitive paint (PSP) layer and a plurality of marker points uniformly distributed on the PSP layer, the system comprising:
a light source configured for stroboscopic illumination to illuminate a whole area of the surface of the measured blade;
a binocular camera configured to capture images of the whole area of the surface of the measured blade;
a photoelectric speed sensor configured to detect a phase-locked position of the measured blade and, in response, generate a phase-locked signal;
a digital delay generator communicatively coupled to the photoelectric speed sensor, the light source, and the binocular camera, the digital delay generator configured to receive the phase-locked signal, in response to the phase-locked signal transmit a first trigger signal to the light source to set timing and duration of the stroboscopic illumination of the light source in real time, and transmit a second trigger signal to the binocular camera to control an exposure time; and
a counter configured to count a number of the stroboscopic illumination and interrupt signal transmissions from the digital delay generator upon reaching a preset count.

5. A synchronous measurement method for measuring pressure and deformation of a blade, the method comprising steps of:
(a) coating a surface of the blade with a pressure-sensitive paint (PSP) layer and disposing a plurality of marker points on the PSP layer;
(b) acquiring a binocular wind-on image by:
(i) rotating the blade to a target operational speed,
(ii) opening a shutter of a binocular camera for a total exposure time,
(iii) repeatedly performing the following substeps during the total exposure time:
(1) detecting when the rotating blade is at a phase-locked position, and
(2) in response to detecting the blade is at the phase-locked position, triggering a light source to produce a single stroboscopic flash of a predetermined duration to illuminate the surface,
(iv) accumulating light from a predetermined number of the stroboscopic flashes onto a sensor of the binocular camera, and
(v) closing the shutter of the binocular camera to complete the acquisition of the binocular wind-on image;
(c) acquiring a binocular wind-off image by repeating the steps of (b) (ii) through (b) (v) while the blade is rotating at a barring speed;
(d) calibrating the binocular camera to determine internal and external camera parameters;
(e) identifying and matching the plurality of marker points in the binocular wind-on image and the binocular wind-off image;
(f) calculating blade deformation information based on a displacement of the matched marker points between the wind-on and wind-off images and the internal and external camera parameters;
(g) after registering the binocular wind-on image to the binocular wind-off image using the calculated blade deformation information, calculating a PSP intensity ratio by comparing the binocular wind-on image and the binocular wind-off image; and
(h) converting the PSP intensity ratio into a pressure distribution on the surface of the blade using a predetermined PSP calibration relationship, thereby obtaining a synchronous measurement of the pressure and the deformation of the blade.
